(19) United States
(12) Patent Application Publication
(10) Pub. No.: US 2022/0405435 A1
(43) Pub. Date: Dec. 22, 2022

(54) METHOD FOR CREATING A VIRTUAL THREE-DIMENSIONAL STRUCTURAL MODEL

(71) Applicant: KTM TECHNOLOGIES GMBH, Salzburg/Anif (AT)

(72) Inventors: David Marschall, Salzburg (AT); Herbert Rippl, Dorfbeuern (AT)

(21) Appl. No.: 17/777,774

(22) PCT Filed: Nov. 19, 2020
(86) PCT No.: PCT/EP2020/082656

§ 371 Date: May 18, 2022

(30) Foreign Application Priority Data
Nov. 19, 2019 (DE) 10 2019 131 243.4
Dec. 20, 2019 (DE) 10 2019 135 526.5

(51) Int. Cl. G06F 30/17; G06F 30/23; G05B 19/4099

(52) U.S. Cl. CPC G06F 30/17; G06F 30/23; G05B 19/4099; G06F 2113/10

(57) ABSTRACT

A method for creating a virtual three-dimensional structural model of a body includes ascertaining a shell geometry and a basic volume from a geometric model of the body; creating a numerical model of the body from the shell geometry and/or the basic volume; acting upon the numerical model with a variable and establishing a target property of the body from the numerical model acted upon by the variable; creating a structural model that defines an actual property of the body; and iteratively optimizing the structural model to align the actual property with the target property. During the optimization, adapting a mechanical, thermal, and/or aerodynamic actual property of the body to a mechanical, thermal, and/or aerodynamic target property of the body by modifying at least one parameter of the structural model. A manufacturing method and a device perform this method.

### CROSS REFERENCE TO RELATED APPLICATIONS

The present application claims priority to application Serial No. PCT/EP2020/082656 filed on Nov. 19, 2020, which is hereby incorporated herein in its entirety by this reference for all purposes.

### FIELD OF THE INVENTION

The present invention relates to a method for creating a virtual three-dimensional structural model of a body. Moreover, the invention relates to an additive manufacturing method, in particular a 3D printing process, for manufacturing a body. Moreover, the invention relates to a device for creating a virtual three-dimensional structural model of a body and/or for producing the body. Moreover, the invention relates to a body manufactured with this method.

### BACKGROUND OF THE INVENTION

For example, WO 2017/123268 A1, which corresponds to US Patent Application Publication No. 2017-0203516, which is hereby incorporated herein in its entirety by this reference for all purposes, describes a system and a method for creating a shape-conforming lattice structure for a part formed by additive manufacturing. The method includes creating a computer model of the part and generating a finite element mesh. A lattice structure including a plurality of cellular lattice components may also be generated. Some of the mesh elements of the finite element mesh may be deformed such that the finite element mesh conforms to the overall shape of the part. The lattice structure may then be deformed such that the lattice structure has a cellular periodicity corresponding to the finite elements of the finite element mesh.

The problem addressed by the present invention is that of eliminating the disadvantages known from the prior art, in particular that of improving the mechanical, thermal, and/or aerodynamic properties of a structure of a body formed from a plurality of cells.

### OBJECTS AND SUMMARY OF THE INVENTION

The problem addressed by the invention is solved by the features described below along with the drawings.

The invention relates to a method for creating a virtual three-dimensional structural model of a body. The term “structure” is to be understood, in particular, to refer to a lattice structure and/or surface structure. The structure can be formed from a plurality of cells. These cells can include multiple structural elements, in particular surface elements and/or lattice elements, which are connected to one another.

In the method, a shell geometry and a basic volume are initially ascertained from a geometric model. The geometric model can be, for example, a CAD model. The shell geometry forms the shell of the virtual body. The basic volume forms the volume enclosed by the shell geometry. Accordingly, the basic volume is at least partially surrounded by the shell geometry. Preferably, this method step is carried out at least partially manually by a user and/or in an automated manner by a processing unit.

Thereafter, in the method according to the invention, at least one numerical model of the body is created under consideration of the shell geometry and/or the basic volume. The numerical model can be an FE model (finite element model) and/or an FV model (finite volume model). Preferably, this method step is carried out at least partially manually by the user and/or in an automated manner by the processing unit.

The numerical model is acted upon by at least one variable. The term “variable” is to be understood essentially to refer to an influencing variable and/or load variable, which acts upon the body during the intended use of the body. The numerical model is acted upon by at least one mechanical, thermal, and/or aerodynamic variable. Preferably, this method step is carried out at least partially manually by the user and/or in an automated manner by the processing unit.

A target property of the body is then established on the basis of the numerical model acted upon by the at least one variable. This is preferably established and/or predefined by a user. Additionally or alternatively, this can be established and/or predefined in an automated manner by the processing unit. In the present case, a mechanical, thermal, and/or aerodynamic target property of the body are/is established on the basis of the numerical model acted upon by the at least one mechanical, thermal, and/or aerodynamic variable. Here, the target properties of the body are preferably established to be mechanically, thermally, and/or aerodynamically anisotropic. This means, the body preferably has direction-dependent mechanical, thermal, and/or aerodynamic target properties. Preferably, this method step is carried out at least partially manually by the user and/or in an automated manner by the processing unit.

Thereafter, a structural model is created. The term “structural model” is to be understood to refer to a virtual model of the body, which is made up of a plurality of cells. The cells can be formed from multiple structural elements, in particular surface elements and/or lattice elements, which are connected to one another. The structural model defines at least one actual property of the body. The structural model defines a mechanical, thermal, and/or aerodynamic actual property of the body. Preferably, this method step is carried out at least partially manually by the user and/or in an automated manner by the processing unit.

Preferably, the numerical model and/or the structural model are/is fitted into the shell geometry. The term “fitted” is to be understood to mean that a cell of the numerical model and/or of the structural model adjacent to the shell geometry is not cut off or divided by the shell geometry, but rather its dimensions are accurately adapted to the shell geometry such that the cell terminates flush with the shell geometry. Preferably, this method step is carried out at least partially manually by the user and/or in an automated manner by the processing unit.

The structural model is iteratively optimized in order to adapt the actual properties to the target properties. In so doing, the at least one mechanical, thermal, and/or aerodynamic actual property of the body is adapted to the mechanical, thermal, and/or aerodynamic target property of the body by modifying at least one parameter of the structural model. Preferably, this method step is carried out at least partially manually by the user and/or in an automated manner by the processing unit. Advantageously, as a result, a structural model can be created, which is distinguished by improved mechanical, thermal, and/or aerodynamic properties.

It is advantageous when the structural model is created under consideration of and/or on the basis of structural proportions of the numerical model. The term “structural proportions” is to be understood to refer to those parameters of a numerical mesh of the numerical model, which define the proportions of the individual cells of the numerical mesh. The structural proportions can be, in particular, the corner points of the numerical mesh of the numerical model, in particular its coordinates. Preferably, the structural model is created on the basis of these structural proportions of the numerical model. Preferably, this method step is carried out at least partially manually by the user and/or in an automated manner by the processing unit.

It is advantageous when the target property and/or the actual property are/is reproduced by at least one property tensor, in particular a stiffness tensor.

It is advantageous when the mechanical, thermal, and/or aerodynamic actual properties of the structural model are ascertained on the basis of the numerical model. Preferably, this method step is carried out at least partially manually by the user and/or in an automated manner by the processing unit.

It is also advantageous when the modified mechanical, thermal, and/or aerodynamic actual properties of the body are aligned with the mechanical, thermal, and/or aerodynamic target properties on the basis of the numerical model. Preferably, this method step is carried out at least partially manually by the user and/or in an automated manner by the processing unit.

In one advantageous enhanced embodiment of the invention, the structural model is formed from a plurality of cells, which include multiple structural elements, in particular surface elements and/or lattice elements, which are connected to one another. The lattice elements can be, for example, rods, which are preferably connected to one another in nodal points.

In order to increase the level of optimization of the structural model, it is advantageous when at least one structural element parameter of at least one, in particular a single, structural element, in particular of a cell, is modified. Preferably, this method step is carried out at least partially manually by the user and/or in an automated manner by the processing unit. Accordingly, it is not the cell in its entirety, but rather one level of detail lower, at least one, in particular a single, structural element of the cell that is affected and optimized. As a result, a cell can be advantageously created, which has an optimized mechanically, thermodynamically, and/or aerodynamically anisotropic behavior.

It is advantageous when the at least one, in particular the single, structural element is modified such that it has mechanically, thermally, and/or aerodynamically anisotropic properties itself. As a result, advantageously, the anisotropic behavior of the cell can be even more precisely affected and established. Preferably, this method step is carried out at least partially manually by the user and/or in an automated manner by the processing unit.

In this regard, it is advantageous when the at least one parameter, in particular structural element parameter, is modified in one longitudinal direction and/or one of its two transverse directions of the structural element. Accordingly, the structural element can preferably be designed such that its mechanical, thermal, and/or aerodynamic properties change, in particular constantly or variably, in at least one of its three spatial directions. Preferably, this method step is carried out at least partially manually by the user and/or in an automated manner by the processing unit.

It is advantageous when, as the structural element parameter, a material parameter and/or a geometric parameter of the structural element are/is modified, in particular, in one of its three spatial directions. Preferably, this method step is carried out at least partially manually by the user and/or in an automated manner by the processing unit. In this regard, it is advantageous when, as the material parameter, a density, a hardness, a strength (in particular tensile strength and/or compressive strength), an elasticity, a ductility, a material damping, a thermal expansion, a thermal conductivity, a heat resistance, a specific heat capacity, and/or a low-temperature toughness of the structural element are/is modified, in particular in one of its three spatial directions. Moreover, it is advantageous in this regard when, as the geometric parameter, a thickness, a length, a cross-sectional shape, and/or a contour of the structural element are/is modified, in particular in one of its three spatial directions.

In one advantageous enhanced embodiment of the invention, the structural element is modified such that this has a variable thickness, in particular across its length. Accordingly, the structural element, in particular a rod element, can taper and/or thicken in areas.

It is advantageous when at least one, in particular the mechanical, thermal, and/or aerodynamic properties-influencing, structural parameter of at least two structural elements of the same cell are designed to be different from one another. As a result, the mechanical, thermal, and/or aerodynamic properties of the cell can be designed to be anisotropic. Moreover, this anisotropic behavior of the cell can be highly precisely set. Preferably, this method step is carried out at least partially manually by the user and/or in an automated manner by the processing unit.

The material properties of a material utilized within the scope of additive manufacturing can change due to temperature conditions changing during the production process. For example, the production space of an additive manufacturing device gradually heats up during additive manufacturing. Consequently, the utilized material cools down faster at the beginning of the production process than at the end of the production process. Due to the different cooling times, material properties of the starting material utilized for additive manufacturing can change. This affects the mechanical, thermal, and/or aerodynamic properties of the additively manufactured body. For this reason, it is advantageous when at least one, in particular the at least one structural element-influencing, production parameter of an additive manufacturing device is taken into account in the iterative optimization of the structural model. In this regard, it is advantageous when the actual properties and/or target properties of the body are adapted as a function of and/or under consideration of this production parameter. Preferably, this method step is carried out at least partially manually by the user and/or in an automated manner by the processing unit.

It is advantageous when a temperature distribution in the interior of a production space of the manufacturing device is taken into account as the production parameter. Additionally or alternatively, it is advantageous when a temperature change in the interior of the production space, in particular during the production of the body, is taken into account. The temperature distribution and/or temperature change can be, for example, empirically ascertained.

In one advantageous enhanced embodiment, at least one parameter of the structural model, in particular at least one structural element parameter of at least a single structural element, changes as a function of a production parameter. As a result, it can be ensured that the temperature conditions changing during the production process do not negatively affect the material properties of the manufactured body. Preferably, this method step is carried out at least partially manually by the user and/or in an automated manner by the processing unit.

It is advantageous when at least one of the aforementioned method steps, in particular the iterative optimization of the structural model, is at least partially carried out by the processing unit, which is preferably designed having an artificial intelligence.

The invention also relates to an additive manufacturing method, in particular a 3D printing process, for manufacturing a body. In this manufacturing method, a virtual three-dimensional structural model of the body is created. Preferably, the method steps for creating the virtual three-dimensional structural model of the body are carried out at least partially manually by a user and/or in an automated manner by a processing unit. Moreover, production data are generated for an additive manufacturing device on the basis of the virtual three-dimensional structural model. Preferably, this method step is carried out at least partially manually by the user and/or in an automated manner by the processing unit. Thereafter, the body is produced with the additive manufacturing device on the basis of the production data. According to the invention, the virtual three-dimensional structural model of the body is created with a method for creating a virtual three-dimensional structural model according to the preceding description, wherein the aforementioned features can be present individually or in any combination.

Moreover, the invention relates to a device for creating a virtual three-dimensional structural model of a body and/or for producing the body. The device includes a processing unit for creating the virtual three-dimensional structural model of the body. Additionally or alternatively, the device includes an additive manufacturing device for producing the body. The processing unit of the device is designed such that the virtual three-dimensional structural model of the body can be created with a method according to the preceding description with the aid of this processing unit, wherein the aforementioned features can be present individually or in any combination and/or the aforementioned method steps can be carried out at least partially manually by the user and/or in an automated manner by the processing unit.

The invention also relates to a body, in particular a component, having a structure, which is formed from a plurality of cells, which includes multiple structural elements, in particular surface elements and/or lattice elements, which are connected to one another. The body is manufactured with a method according to the preceding description, wherein the aforementioned features can be present individually or in any combination and/or the aforementioned method steps are carried out at least partially manually by the user and/or in an automated manner by the processing unit.

It is advantageous when the body includes a support element, to which the structure is connected in a form-locking and/or integral manner. Preferably, the structure is clipped to the support element in a form-locking manner. Additionally or alternatively, the support element can be integrally joined via a connecting material, which is preferably made of the same material of the support element and/or of the structure.

### BRIEF DESCRIPTION OF THE DRAWINGS OF EXEMPLARY EMBODIMENTS

Further advantages of the invention are described in the following exemplary embodiments, wherein:

FIG. 1 shows a schematic representation of a device for creating a virtual three-dimensional structural model of a body and for producing the body,

FIG. 2a shows a single cell of a structure formed of lattice elements,

FIG. 2b shows a single cell of a structure formed of surface elements,

FIG. 2c shows a single cell of a structure formed of lattice elements and surface elements,

FIG. 3 shows a single structural element of a cell, and

FIG. 4 shows a flowchart for a method for creating a virtual three-dimensional structural model of a body, in particular with a processing unit, and/or for the additive manufacturing of this body, in particular with an additive manufacturing device.

### DETAILED DESCRIPTION OF EXEMPLARY EMBODIMENTS OF THE INVENTION

FIG. 1 shows a processing unit 2 for creating a virtual three-dimensional structural model 19 of a body 5. The mode of operation of the processing unit 2 is discussed in detail in the following description, in particular in FIG. 4, wherein the method steps shown therein can be carried out at least partially manually by a user and/or in an automated manner by the processing unit 2. Moreover, FIG. 1 shows an additive manufacturing device 3, with which the body 5 can be manufactured in an additive manufacturing method. The manufacturing device 3 includes a production space 8, in the interior of which the body 5 is manufactured. The additive manufacturing device 3 includes a production unit 4 for manufacturing the body 5. The processing unit 2 and the additive manufacturing device 3, together, form a device 1 for creating the virtual three-dimensional structural model 19 and for the additive manufacturing of the body 5. The body 5 has a structure 6, which is generally indicated in FIG. 1 and is formed from a plurality of cells 7.

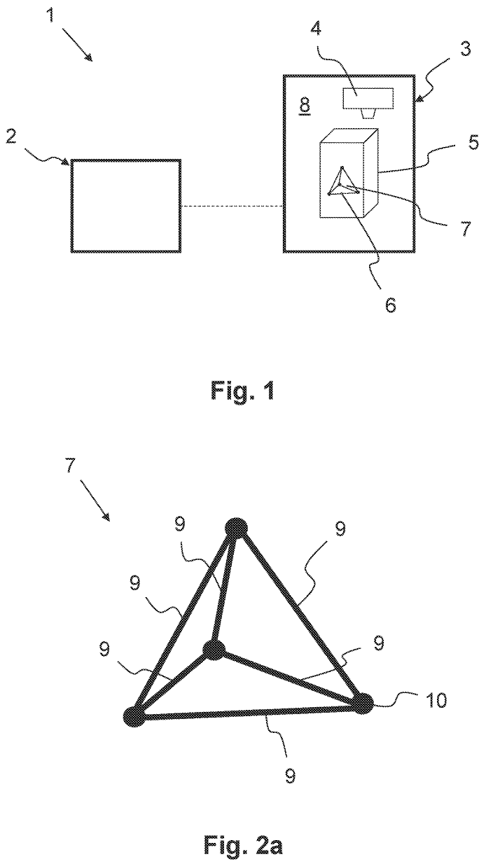

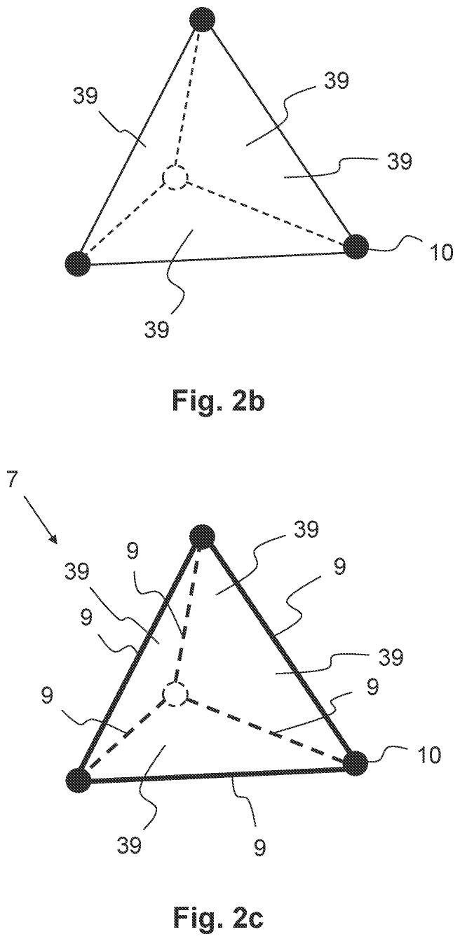

One of these isolated cells 7 is represented in FIG. 2 by way of example. Each of these cells 7 is formed from multiple structural elements 9 connected to one another. The structural elements 9 can be lattice elements such as elongated rods, as represented in FIG. 2a. Alternatively as schematically shown in FIG. 2b, the structural elements 9 can also be formed as surface elements 39, which intersect with one another along common edges and have nodes 10 where three surface elements 39 meet. Alternatively, as schematically shown in FIG. 3c, each cell 7 can be formed of a combination of a plurality of lattice elements 9, and surface elements 39, however. The opposite ends of the structural elements 9 that are lattice elements 9 can be connected via nodes 10, only one of which is provided with a reference character in FIG. 2a for the sake of clarity.

FIG. 3 shows a single structural element 9 of a cell 7. The present structural element 9 is designed to embody anisotropic properties. Consequently, the structural element 9 has properties that differ depending on the direction. For this purpose, at least one structural element parameter 11 (FIG. 4) of the structural element 9 is modified. The structural element parameter 11 can be a material parameter 12 and/or a geometric parameter 13 (cf. FIG. 4). Material parameters 12 can be, for example, density, hardness, strength, elasticity, ductility, material damping, thermal expansion, thermal conductivity, heat resistance, specific heat capacity, and/or low-temperature toughness. Thus, the structural element 9 can have other material parameters 12, for example, in a first section 14, than in a second section 15, which is separated by the dashed line from the first section 14. In this example, the material parameters 12 therefore change in a transverse direction (i.e., parallel to the plane in which the first section 14 and second section 15 lie) of the structural element 9. Alternatively, however, the structural element parameters 11 can also change in a longitudinal direction (which is normal to the transverse direction) of the structural element 9. In the present exemplary embodiment, a geometric parameter 13 changes. Geometric parameters 13 can be the thickness, length, cross-sectional shape, and/or contour of the structural element 9. As FIG. 3 shows, in the present structural element 9, the thickness (measured in the transverse direction) of the structural element 9 changes as a function of its longitudinal position across its length.

FIG. 4 shows a flowchart for a manufacturing method for manufacturing the body 5. Moreover, FIG. 4 shows a method for creating a virtual three-dimensional structural model of the body 5. This method for creating a virtual three-dimensional structural model of the body 5 is carried out with the processing unit 2 shown in FIG. 1. Preferably, the aforementioned method steps are carried out at least partially manually by a user and/or in an automated manner by the processing unit 2. In particular, it can happen that the processing unit 2 depends on input data that must be input by a user and that are then processed by the processing unit 2. The subsequent step of additive manufacturing is carried out with the additive manufacturing device 3 represented in FIG. 1.

Production parameters 28 of the additive manufacturing device 3 are taken into account in the present method. These production parameters 28 can include a temperature distribution in the production space 8 of the manufacturing device 3. The production parameters can preferably be detected via sensors and/or manually input by the user. Moreover, a temperature change in the interior of the production space 8 during the manufacturing process can be taken into account as a production parameter 28. Different temperatures prevail in the production space 8, which also change during the production process. One area of the additively manufactured body 5 can cool down faster in one area of the production space 8 than in another area of the production space 8. Therefore, the material properties of the body 5 change as a function of the progression of the cooling. A material data gathering 17 is therefore carried out in order to be able to take this effect of the manufacturing device 3 into account. The effect of the material properties as a function of the production parameters 28 of the manufacturing device 3 is empirically ascertained within the scope of test production and subsequent materials testing. These production-related material data 29 can also be and/or include limiting values for material properties. The production-related material data 29 ascertained within the scope of the material data gathering 17 are incorporated at different points, as explained in detail in the following.

In order to create the virtual three-dimensional structural model 19 of the body 5, a geometric model 16 of the body 5 is initially created. The geometric model 16 of the body 5 desirably can be provided as a CAD model. A shell geometry 25 and a basic volume 26 are ascertained on the basis of the geometric model 16. The shell geometry 25 forms the outer shell of the body 5. The basic volume 26 is therefore enclosed by the shell geometry 25. Preferably, this method step is carried out at least partially manually by the user and/or in an automated manner by the processing unit 2.

Thereafter, a first numerical model 18 of the body 5 is created. Preferably, this method step is carried out at least partially manually by the user and/or in an automated manner by the processing unit 2. The previously ascertained shell geometry 25 and/or the basic volume 26 are/is taken into account during the creation of the numerical model 18. The numerical model 18 includes a numerical mesh, which is preferably formed from numerical elements and/or corner points connecting these numerical elements to one another. The numerical model 18, in particular its numerical mesh, is fitted into the shell geometry 25. Preferably, this method step is carried out at least partially manually by the user and/or in an automated manner by the processing unit 2. Consequently, the numerical mesh of the numerical model 18 does not protrude from the shell geometry 25, but rather is fitted therein so as to rest directly against the shell geometry 25. The numerical cells located in the edge area of the numerical mesh are therefore not cut off by the shell geometry 25, but rather are all complete and/or closed.

The numerical model 18 can be an FE model (finite element model) and/or an FV model (finite volume model). The numerical model 18 is acted upon by at least one variable 27 and/or multiple variables (load collective). Preferably, this method step is carried out at least partially manually by the user and/or in an automated manner by the processing unit 2. These can be influencing variables, which act upon the body 5 during the intended use of the body 5. The variables 27 are preferably mechanical, thermal, and/or aerodynamic variables 27. Additionally, the production parameters 28 can be taken into account in this step via the production-related material data 29. Preferably, this method step is carried out at least partially manually by the user and/or in an automated manner by the processing unit 2. Target properties 30 of the body 5 are established on the basis of the first numerical model 18 under consideration of the applied variables 27 and/or production-related material data 29. This is preferably carried out manually by a user on the basis of empirical values. Alternatively, this can also be carried out, however, in a fully automated manner by the processing unit 2, which can preferably employ an artificial intelligence for this purpose. The target properties 30 are mechanical, thermal, and/or aerodynamic target properties 30. These mechanical, thermal, and/or aerodynamic target properties 30 therefore form the reference values, which the structure 6 of the body 5 to be ascertained are targeted to have.

The first numerical model 18 has structural proportions 33. The term “structural proportions” is to be understood to refer to those parameters of the first numerical mesh of the numerical model 18, which define the proportions of the individual cells of the numerical mesh. The structural proportions 33 can be, for example, the corner points of the first numerical mesh of the numerical model 18, in particular its coordinates.

In order to ascertain the structure 6, a first structural model 19 is initially created. This step of initially creating a first structural model 19 takes place on the basis of the structural proportions 33 of the numerical model 18. For this purpose, the structural proportions 33 are transferred to the first structural model 19. The structural proportions 33 are utilized to fit the structural model 19 into the shell geometry 25. Alternatively, the fitting of the structural model 19 into the shell geometry 25 can be carried out in this step. Consequently, the structure of the structural model 19 does not protrude from the shell geometry 25, but rather is fitted therein so as to rest directly against the shell geometry 25. The cells 7 located in the edge area of the structure are therefore not cut off by the shell geometry 25, but rather are all complete and/or closed. The structural model 19 yields at least one actual property tensor 31. Due to this at least one actual property tensor 31 of the structural model 19, mechanical, thermal, and/or aerodynamic actual properties 32 of the mathematical model are defined. In order to check these actual properties 32, the at least one actual property tensor 31 of the structural model 19 is transferred into a second numerical model 20. The production-related material data 29 of the material data gathering 17 can also be taken into account in the construction of this second numerical model 20. Preferably, the aforementioned method steps are carried out at least partially manually by the user and/or in an automated manner by the processing unit 2.

Thereafter, a check is carried out to determine whether the actual properties 32 of the structural model 19 or of the second numerical model 20 correspond to the previously established target properties 30 of the first numerical model 18. This takes place within the scope of a target-actual comparison 21. Preferably, this method step of the target-actual comparison 21 is carried out at least partially manually by the user and/or in an automated manner by the processing unit 2.

If the mechanical, thermal, and/or aerodynamic actual properties 32 still deviate too greatly from the mechanical, thermal, and/or aerodynamic target properties 30, an iterative optimization of the structural model 19 is carried out. Within the scope of this iterative optimization, a predetermined extent of the degree that the actual properties 32 are required to be aligned with the target properties 30 determines when the iterative optimization has been satisfied. Preferably, this method step is carried out at least partially manually by the user and/or in an automated manner by the processing unit 2.

In order to modify the actual properties 32, a parameter adaptation 22 is carried out. Preferably, this method step is carried out at least partially manually by the user and/or in an automated manner by the processing unit 2. At least one parameter, in particular a structural element parameter 11, of the structural model 19 is modified. The term “structural element parameter” is to be understood to refer to a parameter of a single structural element 9. Accordingly, at least one structural element parameter 11 of at least a single structural element 9 of a cell 7 is modified (cf. FIG. 2). The structural element 9 can be modified, for example, as represented in FIG. 3. The at least one single structural element 9 is modified to assume properties that are mechanically, thermally, and/or aerodynamically anisotropic. The at least one structural element parameter 11 can be variably designed in one spatial direction of the structural element 9. The structural element parameter 11 can be a material parameter 12 and/or a geometric parameter 13 of the structural element 9. Consequently, the structural model 19 can therefore have at least one cell 7, in which at least one structural element parameter 11 of at least two structural elements 9 of the same cell 7 are designed differently from one another.

The mechanical, thermal, and/or aerodynamic properties of the structural model 19 that have been adapted according to the modified structural element parameters 11, are thereafter transferred to the second numerical model 20 via the at least one actual property tensor 31. Thereafter, a target-actual comparison 21 is carried out again. Preferably, this method step is carried out at least partially manually by the user and/or in an automated manner by the processing unit 2.

If the actual properties 32 correspond sufficiently well to the target properties 30 according to a predetermined standard of correspondence that is suited to the actual properties 32, then a production data generation 23 step is carried out. In this production data generation 23 step, production data that are suitable for the additive manufacturing device 3 are generated. Preferably, this method step is carried out at least partially manually by the user and/or in an automated manner by the processing unit 2. The production-related material data 29 can also be taken into account in the production data generation 23. The result thereof is a precise positioning of the body 5 to be manufactured in the production space 8 of the manufacturing device 3. In the final step, the production 24 then takes place in the manufacturing device 3.

A body 5 that is a component of a complex machine or manufacture has a structure 6 that is formed from a plurality of cells 7. As shown in FIG. 2, each cell 7 of the body 5 includes a plurality of structural elements 9 that are connected to one another. Each of the cells 7 desirably can include a plurality of lattice elements 9 having opposite ends connected at a node 10 as schematically shown in FIG. 2a. Each of the cells 7 desirably can include a plurality of surface elements 39 as schematically shown in FIG. 2a. Alternatively, each of the cells 7 desirably can include a plurality of lattice elements 9 and a plurality of surface elements 39 being bordered by a plurality of connected lattice elements 9. Moreover, the body 5 also desirably includes a support element, which desirably is connected to the structure in a form-locking manner and/or in an integral manner.

The body 5 desirably has been manufactured according to a manufacturing method that uses an additive manufacturing device 3. The method includes the following steps. A virtual three-dimensional structural model 19 of the body 5 is created. On the basis of the virtual three-dimensional structural model 19, production data 29 is created for the additive manufacturing device 3. On the basis of the production data 29, the additive manufacturing device 3 is operated to produce the body 5.

The additive manufacturing device includes a processing unit 2 that is configured to perform a method of creating a virtual three-dimensional structural model 19 of a body 5 from a geometric model 16 of the body 5, and the method performed by the processing unit 2 includes at least the following steps. From a geometric model 16 of the body 5, the processing unit 2 ascertains a shell geometry 25 of the body 5 and a basic volume 26 of the body 5. The processing unit 2 creates a numerical model 18 of the body 5 from either the basic volume 26 of the body 5, the shell geometry 25 of the body 5 or from a combination of the basic volume 26 and the shell geometry 25. The processing unit 2 acts upon the numerical model 18 with a variable 27. Moreover, the processing unit 2 establishes a target property 30 of the body 5 from the numerical model 20 acted upon by the variable 27. The processing unit 2 creates a structural model 19 that defines an actual property 32 of the body 5. The processing unit 2 performs an iterative optimization of the structural model 19 in a way that aligns the actual property 32 with the target property 30. Moreover, the processing unit 2 that performs the iterative optimization of the structural model 19, desirably is a processing unit that is controlled by an artificial intelligence.

The present invention is not limited to the represented and described exemplary embodiments. Modifications within the scope of the claims are also possible, as is any combination of the features, even if they are represented and described in different exemplary embodiments.

### LIST OF REFERENCE CHARACTERS

1 device
2 processing unit
3 additive manufacturing device
4 production unit
5 body
6 structure of body 5
7 cell
8 production space of additive manufacturing device 3
9 structural element of structure 6 of body 5
10 node
11 structural element parameter
12 material parameter
13 geometric parameter
14 first section of the structural element 9
15 second section of the structural element 9
16 geometric model
17 material data gathering
18 first numerical model
19 structural model
20 second numerical model
21 target-actual comparison
22 parameter adaptation
23 production data generation
24 production
25 shell geometry
26 basic volume
27 variable
28 production parameter
29 production-related material data
30 target property of the body 5
31 actual property tensor
32 actual property of the body 5
33 structural proportions
39 surface elements of the structure 6 of the body 5

1. A method for creating a virtual three-dimensional structural model of a body from a geometric model of the body, the method including the following steps:
ascertaining a shell geometry and a basic volume from the geometric model of the body;
creating a numerical model of the body from the shell geometry and/or from the basic volume;
acting upon the numerical model with a variable and establishing a target property of the body from the numerical model acted upon by the variable;
creating a structural model that defines an actual property of the body; and
performing an iterative optimization of the structural model to align the actual property with the target property, wherein during the iterative optimization of the structural model, a mechanical, thermal, and/or aerodynamic actual property of the body is adapted to a mechanical, thermal, and/or aerodynamic target property of the body by modifying at least one parameter of the structural model.

2. The method of claim 1, wherein the numerical model and/or the structural model are/is fitted into the shell geometry.

3. The method of claim 1, wherein the structural model is created under consideration of and/or on the basis of structural proportions of the numerical model.

4. The method of, claim 1, wherein the structural model is formed from a plurality of cells, which include multiple structural elements, which include surface elements and/or lattice elements, which are connected to one another.

5. The method of claim 4, wherein a structural parameter of at least one single structural element is modified.

6. The method of claim 5, wherein the at least one single structural element is modified to have mechanically, thermally, and/or aerodynamically anisotropic properties.

7. The method of claim 5, wherein the structural parameter is modified in a longitudinal direction and/or transverse direction of the structural element.

8. The method of claim 5, further comprising the step of modifying the structural parameter, a material parameter and/or geometric parameter of the structural element.

9. The method of claim 8, further comprising the step of modifying the material parameter, a density, hardness, strength, elasticity, ductility, material damping, thermal expansion, thermal conductivity, heat resistance, specific heat capacity, and/or low-temperature toughness of the structural element.

10. The method of claim 8, further comprising the step of modifying a geometric parameter, a thickness, length, cross-sectional shape, and/or contour of the structural element.

11. The method of claim 4, wherein a structural parameter of at least two structural elements of the same cell are designed to be different from one another.

12. The method of claim 1, wherein a production parameter of an additive manufacturing device is taken into account in the iterative optimization of the structural model.

13. The method of claim 12, wherein the production parameter that is taken into account includes a temperature distribution in the interior of a production space of the manufacturing device and/or a temperature change in the interior of the production space.

14. The method of claim 12, further comprising the step of modifying a structural element parameter (11) of at least one single structural element as a function of a production parameter.

15. The method of claim 1, wherein the iterative optimization of the structural model is performed by a processing unit that is controlled by an artificial intelligence.

16. A 3D printing process for manufacturing a body, the process including the following steps:
creating a virtual three-dimensional structural model of the body;
creating production data for an additive manufacturing device on the basis of the virtual three-dimensional structural model; and
producing the body with the additive manufacturing device on the basis of the production data; wherein the additive manufacturing device includes a processing unit that is configured to perform a method of creating a virtual three-dimensional structural model of a body from a geometric model of the body, the method including the following steps:
ascertaining a shell geometry and a basic volume from a geometric model of the body;
creating a numerical model of the body from the shell geometry and/or from the basic volume;
acting upon the numerical model with a variable and establishing a target property of the body from the numerical model acted upon by the variable;
creating a structural model that defines an actual property of the body; and
performing an iterative optimization of the structural model to align the actual property with the target property, wherein during the iterative optimization of the structural model, a mechanical, thermal, and/or aerodynamic actual property of the body is adapted to a mechanical, thermal, and/or aerodynamic target property of the body by modifying at least one parameter of the structural model.

17. A device for creating a virtual three-dimensional structural model of a body and/or for producing the body with a virtual three-dimensional structural model of the body, the device comprising:
an additive manufacturing device configured for producing the body,
wherein the additive manufacturing device includes a processing unit is designed such that the virtual three-dimensional structural model of the body can be created with this processing unit according to a method that includes the following steps:
ascertaining a shell geometry and a basic volume from a geometric model of the body;
creating a numerical model of the body from the shell geometry and/or from the basic volume;
acting upon the numerical model with a variable and establishing a target property of the body from the numerical model acted upon by the variable;
creating a structural model that defines an actual property of the body; and
performing an iterative optimization of the structural model to align the actual property with the target property, wherein during the iterative optimization of the structural model, a mechanical, thermal, and/or aerodynamic actual property of the body is adapted to a mechanical, thermal, and/or aerodynamic target property of the body by modifying at least one parameter of the structural model.

18. (canceled)

19. (canceled)
